(19) United States
(12) Patent Application Publication
(10) Pub. No.: US 2002/0194997 A1
(43) Pub. Date: Dec. 26, 2002

(54) Electrostatic separator

(76) Inventors: Stephan Ahlborn, Seden (DE); Heiko Schumann, Munster (DE)

Correspondence Address: Lahive & Cockfield, 28 State Street 24th Floor, Boston, MA, 02109, US

(21) Appl. No.: 10/070,865

(22) PCT Filed: Jun. 30, 2001
(86) PCT No.: PCT/DE01/02487

(30) Foreign Application Priority Data
Jul. 11, 2000 (DE) 10033642.6

(51) Int. Cl. B03C 3/16

(52) U.S. Cl. 96/28

(57) ABSTRACT

The invention relates to an electrostatic precipitator for collecting liquid or solid particles from a gas stream. The electrostatic precipitator consists of a tube (1), through which the gas to be cleaned flows longitudinally, the internal wall (1A) of the tube forming a precipitating electrode for the particles to be collected. An internal electrode (2) extending in a lengthwise direction is disposed concentrically inside tube (1), a high electrical voltage being present in the space between this internal electrode and the precipitating electrode. On the inlet side, internal electrode (2) has a first section (2A) with a small cross-sectional area, and on the outlet side, a second section (2B) with a comparatively larger cross-sectional area. The function of the first section is essentially to form a corona while that of the second section is essentially to form an electrostatic collecting field. A cleaning body (3) is provided to clean the section of the internal electrode forming the corona, the cleaning body being moved relative to and in physical contact with the internal electrode so as to clean the section of the internal electrode forming the corona. The actuating element (4) effecting the relative movement is arranged in a space-saving manner inside the hollow internal electrode (2).

The invention relates to an electrostatic precipitator for collecting liquid or solid particles from a gas stream, as provided in the preambles of claims 1 or 12.

Electrostatic precipitators of this type are known from German Patent 198 22 332 C1. The patent describes an actuating means (for example, a thermally actuatable wax expansion element) which moves the cleaning body and is located outside the tube forming the precipitating electrode, which actuating means is movably connected to the cleaning body via a bracket arm and a retaining arm. This system requires additional space in which to configure and accommodate the actuating means, this space becoming unavailable for many applications, for example, for operating an electrostatic precipitator attached to an internal combustion engine.

The goal of the invention is therefore to develop an electrostatic precipitator for cleaning the section of the internal electrode which forms the corona while featuring a compact and space-saving design.

This goal is achieved by the characteristic features listed in claims 1 or 12. Advantageous embodiments of the invention are provided in the subclaims.

The basic principle of the invention is to advantageously make available previously unused space by exploiting the hollow shape of the internal electrode in that section in which the internal electrode has a larger diameter, this space being used to accommodate the components operating the cleaning mechanism.

Integration of the actuating element and/or associated power-transmission means in the internal electrode achieves the overall goal of a compact and space-saving design for the electrostatic precipitator. No more space is required for the electrostatic precipitator according to the invention than would be required for an electrostatic precipitator in which the corona region of the internal electrode is not cleaned. The need for an attachment of components additional to the tube forming the precipitating electrode is entirely eliminated or kept to a minimum.

Embodiments of the invention will be explained in more detail based on the drawing.

FIG. 1 shows a section through a first embodiment of the electrostatic precipitator in which a needle forming the second section of the internal electrode is slid over a fixed cleaning body to effect cleaning, this electrostatic precipitator being employed in an internal combustion engine and shown in its position with the engine running.

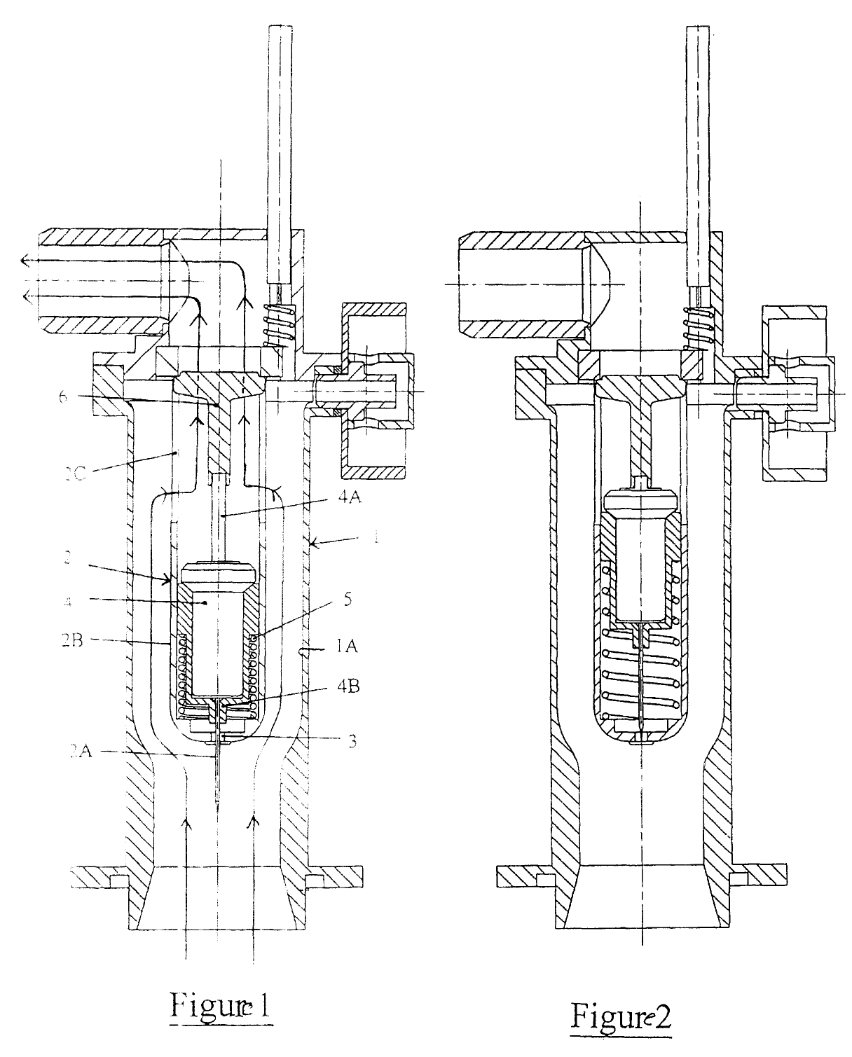

FIG. 2 provides the same view as FIG. 1 in the position with the engine shut off.

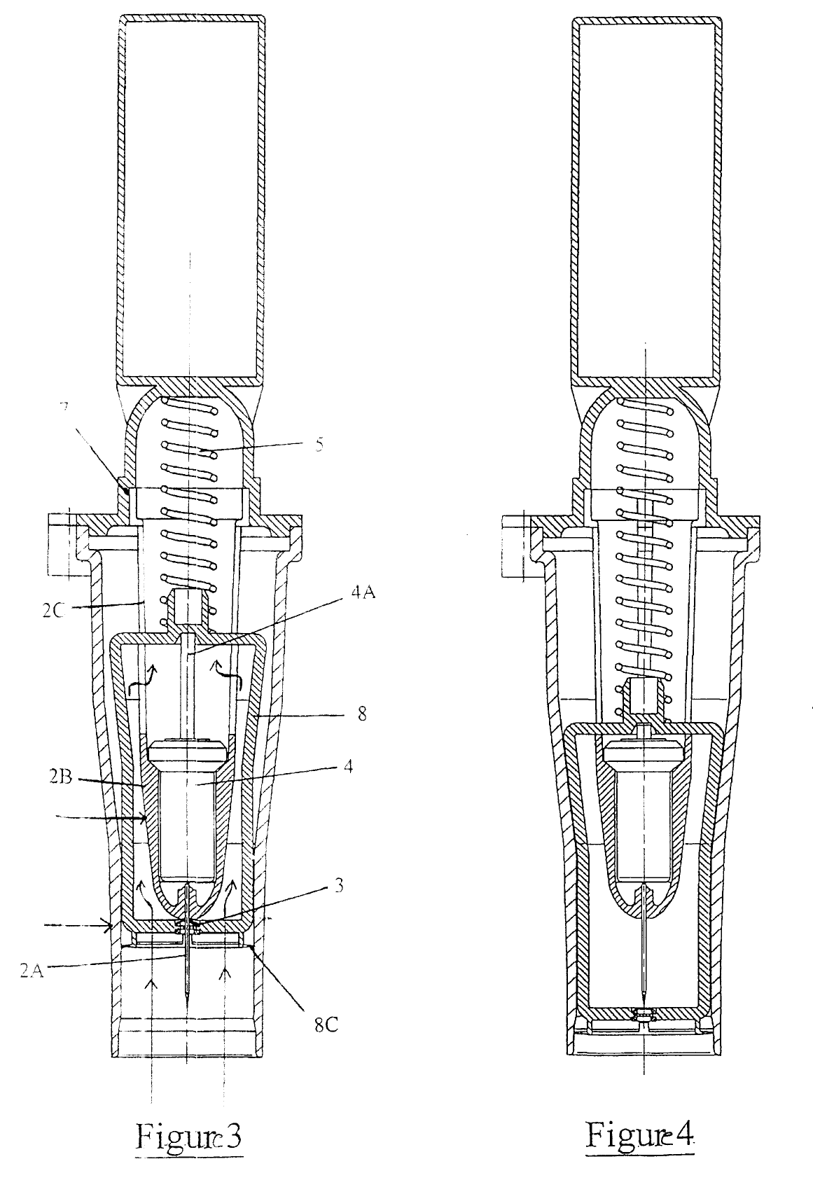

FIG. 3 shows a section through a second embodiment of the electrostatic precipitator in which a needle forming the first section of the internal electrode is slid over a fixed cleaning body to effect cleaning, this electrostatic precipitator being employed in an internal combustion engine and shown in its position with the engine running.

FIG. 4 provides the same view as FIG. 3 in the position with the engine shut off.

FIG. 5 shows a section through a third embodiment of the electrostatic precipitator.

FIG. 6 shows a side view of a hollow, slotted internal electrode with a retaining element for the cleaning body.

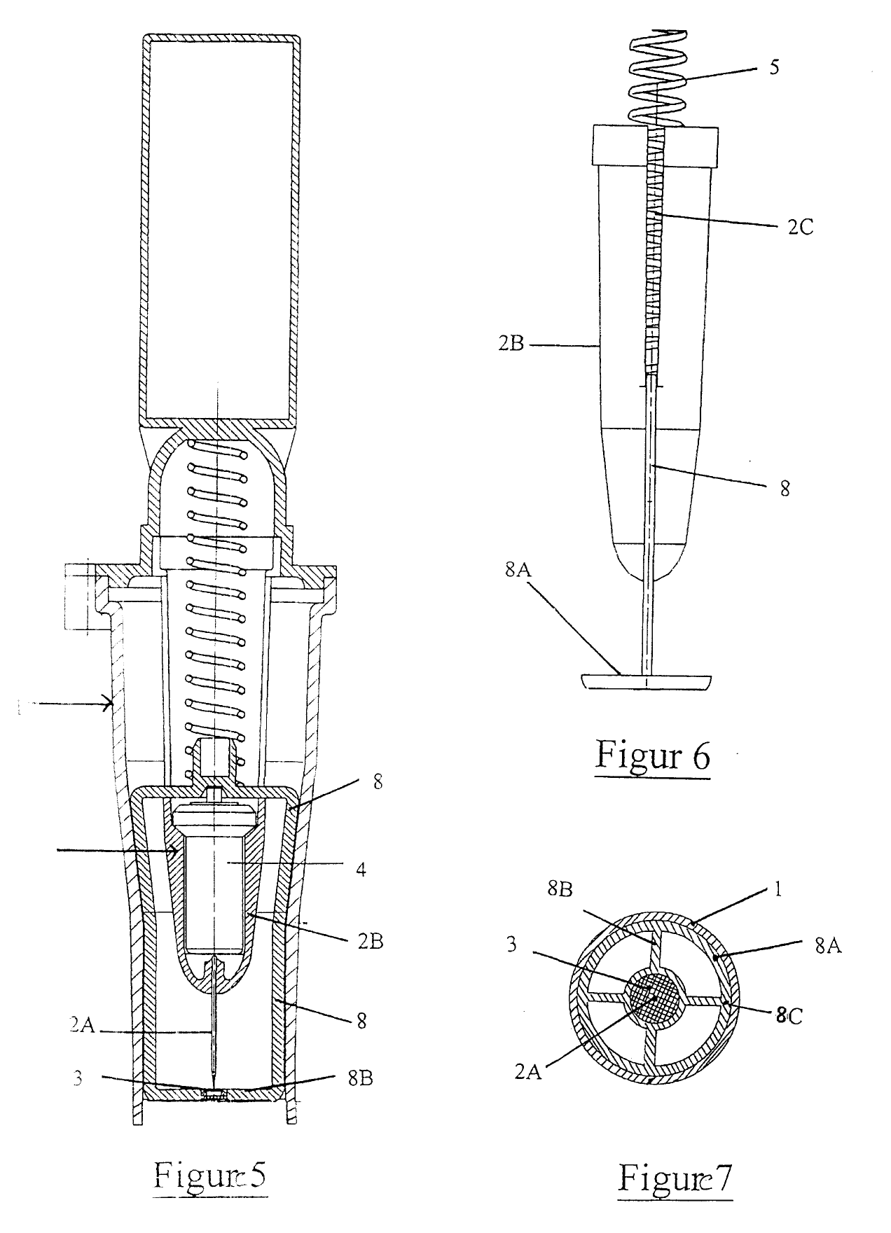

FIG. 7 shows a cross section through the precipitating electrode in the region of the cleaning body and of the retaining element.

FIG. 1 and FIG. 2 each show a section through a first embodiment of the electrostatic precipitator which is employed preferably in an internal combustion engine for removing the oil from crankcase gases. FIG. 1 shows the electrostatic precipitator in its position with the engine running while FIG. 2 shows the electrostatic precipitator with the engine turned off. The electrostatic precipitator consists of a tube (1) through which the gas to be cleaned flows in a lengthwise direction and in which its internal wall (1A) forms a precipitating electrode for the collecting particles. Disposed concentrically inside tube (1) is an internal electrode (2) extending in a lengthwise direction, a high electrical voltage being present in the space between this internal electrode (2) and precipitating electrode (1A). On the inlet side, internal electrode (2) has a first section (2A) with a small cross-sectional area, and on the outlet side, a second section (2B) with a comparatively larger cross-sectional area. The function of first section (2A) is essentially to form a corona while that of second section (2B) is essentially to form an electrostatic collecting field. This two-stage design of internal electrode (2), in which the corona is restricted to a certain section (2A) and does not extend over the entire length of internal electrode (2), ensures in known fashion the economical operation of the electrostatic precipitator in terms of the electrical power required, while at the same time ensuring efficient collection. The preferred design here for the section (2A) of the internal electrode (2) forming the corona is preferably as a needle. However, a design may also be provided, for example, in which the first section (2A) forming the corona is conical on the inlet side or a generally tapered extension of second section (2B) of internal electrode (2).

A cleaning body (3) is provided to clean needle (2A). Cleaning is performed by a relative movement of cleaning body (3) relative to needle (2A), in physical contact with the latter. The actuating means (4) to produce this relative movement is located, according to the invention, in the hollow second section (2B) of internal electrode (2). In the embodiment shown in FIGS. 1 and 2, to effect cleaning needle (2A) slides over fixed cleaning body (3), while in the embodiments shown in FIGS. 3 through 7, cleaning body (3) slides over fixed needle (2A).

When using the electrostatic precipitator attached to an internal combustion engine, an actuating means (4) is preferred which effects the relative movement between the cleaning bodies by utilizing engine-inherent energies such as temperature or pressure differences, or vibrations. When using the electrostatic precipitator for removing the oil crankcase gases, an expansion element (4) is preferably used which expands when the engine is running as a result of heat input from the hot crankcase gases, thereby exerting a force on a plunger (4A) which extends against a counteracting spring. When the engine is off, the temperature drops to ambient levels and the plunger (4A) is retracted by the action of a spring (5). Spring (5) is also accommodated in the hollow internal electrode (2) and may be designated as a return actuating element. Needle (2A) is located in a sleeve (4B) connected on the inlet side with expansion element (4). The needle may, for example, be pressed into this sleeve. Sleeve (4B) may be connected to expansion element (4) as a single piece, or attached to this element as a separate component. Plunger (4A) is located on the side of expansion element (4) opposite needle (2A), this plunger being supported inside hollow internal electrode (2) on a fixed pin (6) therein which acts a support. Spring (5) is supported on one side by a contour of internal electrode (2), and on the other side by a projection of expansion element (4) or by a projection of the body (for example, the above-mentioned sleeve) surrounding the expansion element.

Cleaning body (3) is preferably located at the inlet end of hollow second section (2B) of internal electrode (2). To accommodate it, internal electrode (2) has a small opening there into which cleaning body (3) is pressed or clipped. The cleaning body (3) itself is preferably is formed from an elastomer lamella which is pierced by needle (2A) for cleaning. However, the invention also provides, for example, for designing the cleaning body as a cleaning brush with radially inward-projecting microbristles.

The operating principle of the needle cleaning according to the embodiment of FIGS. 1 and 2 is the following: After the engine is switched on, the hot crankcase gases, as well as the entire engine compartment, heat up expansion element (4). In response, plunger (4A) supported against pin (6) extends and pushes expansion element (4) along with its attached needle (2A) downward, in the drawing, against the force of spring (5). As a result, needle (2A) pierces cleaning body (3). When the engine is running and the electrostatic precipitator is operating, needle (2A), functioning as the section of the internal electrode (2) forming the corona, projects from the second section (2B) of internal electrode (2). When the engine is off and cooled, pretensioned spring (5) returns expansion element (4) along with needle (2A), thereby retracting plunger (4A). During this movement, needle (2A) is cleaned during retraction by contact with cleaning body (3), the contamination being stripped off.

In order to heat up expansion element (4) and thus move needle (2A) into the operating state as quickly as possible after the engine is switched on, the hot crankcase gases are diverted through hollow electrode (2) in which expansion element (4) is of course located. Hollow electrode (2) has inlet openings (2C) for the gas, which connect the space between internal electrode (2) and precipitating electrode (1A) with the cavity in internal electrode (2). These openings are preferably designed as slots (2C) oriented longitudinally to internal electrode (2). A pin (6), which also serves as an end support for plunger (4A), is advantageously inserted through these slots (2C) into internal electrode (2), and held in place there. The diversion of the cleaned gas through hollow internal electrode (2) additionally enables the electrostatic precipitator to have a compact design.

In the embodiment of FIGS. 1 and 2, needle (2A) is maintained at the same potential as internal electrode (2) via sleeve (4B) which is in electrically conductive contact with the second hollow section (2B) of internal electrode (2).

Creation of a smaller diameter for tube (1) may be achieved by modifying the embodiment of FIGS. 1 and 2 so that expansion element (4) is not located completely inside tube (1) but instead only plunger (4A) of expansion element (4) extends into tube (1), in other words, so that the main body of expansion element (4) in the drawing is located, for example, above plunger (4A).

In the embodiment of FIGS. 3 through 7, needle (2A) is permanently attached (for example, pressed into) to the second hollow section (2B) of internal electrode (2). Here cleaning body (3) moves while needle (2A) remains fixed in place. To achieve this, a retaining element (8) for cleaning body (3) is provided which is connected to plunger (4A) of expansion element (4), this retaining element (8) moving along with plunger (4A). To receive retaining element (8) in a longitudinally movable manner and to connect retaining element (8) with plunger (4A), hollow internal electrode (2) has longitudinally oriented slots (2C). In this case as well, the slots (2C) serve to divert the hot crankcase gases through hollow internal electrode (2). In the variant shown, retaining element (8) is designed as a retaining bracket which, on the inlet side, has a ring (8A) to accommodate cleaning body (3). The gas to be cleaned may flow past the connecting members (8B), which hold cleaning body (3) concentrically inside ring (8A), into tube (1). To center cleaning body (3) in alignment with needle (1A), retaining bracket (8) is aligned coaxially by ring (8C) inside precipitating electrode (1A). This arrangement is illustrated more clearly in FIG. 7. It ensures that cleaning ring (3) is always pierced by needle (2A) in the same place. This feature is advantageous particularly when cleaning body (3) has an elastomer composition since the elastomer would otherwise be quickly destroyed by a plurality of puncture points, whereas the electrostatic precipitator is designed to be a maintenance-free, durable component.

In the embodiment shown in FIGS. 3 through 5, spring (5) is supported at one end by retaining element (8), and at the other end by a closing cap (7) which closes tube (1).

As shown in FIGS. 3 and 4, retaining element (8) also has a circumferential cleaning lip (8C) for cleaning precipitating electrode (1A). Advantageously, both needle (2A) and precipitating electrode (1A) may thus be cleaned simultaneously by a single mechanism. In addition, cleaning lip (8C) may also serve—as mentioned above—to center cleaning body (3).

In an embodiment not shown, the plunger of the expansion element is designed as the needle forming the corona, the spring resting here on a support collar connected to the plunger.

Instead of employing an expansion element plus spring to effect the relative movement between the cleaning body and needle, it is also possible, for example, to use as an actuating element a motor-driven threaded spindle running through the hollow internal electrode. It is also possible to provide a cylinder operated by oil pressure or air pressure as the actuating element, the cylinder in this case extending at least along part of the hollow internal electrode.

One aspect of the invention which is independent of the corona-forming needle is the exclusive cleaning of the precipitating electrode by an actuating mechanism located in the cavity of the internal electrode. For example, retaining element (8), as shown in FIGS. 3 and 4, may be used to form a cleaning device, the retaining element here having only one circumferential cleaning lip (8C). In this case, retaining element (8) is not required to accommodate cleaning body (3).

List of Drawing References

1) tube

1a) internal wall/precipitating electrode

2) internal electrode

2a) first section of internal electrode/needle

2b) second section of internal electrode

2c) slots in internal electrode

3) cleaning body

4) actuating means (expansion element) for effecting the relative movement of cleaning body and needle

4a) plunger

4b) sleeve on expansion element to accommodate needle

5) spring

6) pin functioning as end support for plunger

7) closing cap of tube

8) retaining element for cleaning body

8a) ring

8b) connecting members

8c) cleaning lip for precipitating electrode

1. Electrostatic precipitator for collecting liquid or solid particles from a gas stream, consisting of a tube (1) through which the gas to be cleaned flows longitudinally and in which the internal wall (1A) forms a precipitating electrode for the collecting particles, and of an internal electrode disposed concentrically and longitudinally inside the tube (1), wherein a high electrical voltage is present in the space between this electrode (2) and the precipitating electrode (1A), the internal electrode (2) has a first section (2A) with a small cross-sectional area on the inlet side, and a second section (2B) with a comparatively larger cross-sectional area on the outlet side, the first section (2A) serving essentially to form the corona, and the second section (2B) serving essentially to form an electrostatic collecting field, of a cleaning body (3) for cleaning the section (2A) of the internal electrode (2) forming the corona, the cleaning being effected by a relative movement of the cleaning body (3) against the section (2A) of the internal electrode (2) forming the corona and in contact with this section, of at least one actuating means (4) to effect the relative movement between cleaning body (3) and the section (2A) of the internal electrode (2) forming the corona, characterized in that at least the second section (2B) of the internal electrode (2) is of a hollow design, the cavity of the internal electrode (2) accommodating at least one part of the actuating means (4) and/or at least one power-transmission means connected to the actuating means (4) by which to effect the relative movement between cleaning body (3) and the section (2A) of the internal electrode (2) forming the corona.

2. Electrostatic precipitator according to claim 1, the precipitator being attached to an internal combustion engine, characterized in that the actuating means (4) effects the relative movement between the cleaning body (3) and the section (2A) of the internal electrode (2) forming the corona by utilizing engine-inherent energies such as temperature or pressure differences, or vibrations.

3. Electrostatic precipitator according to claim 2, characterized in that the actuating means (4) is an expansion element which is connected thermally or by a pressure line to an engine-inherent energy source, wherein when the engine is running, the expansion element (4) holds, against a counteracting spring (5), the first section (2A) of the internal electrode (2) in a first position relative to the cleaning body (3) which is fixed inside the electrostatic precipitator, when the engine is off, the first section (2A) of the internal electrode (2) is held by a spring in a second position relative to the cleaning body (3) which is fixed inside the electrostatic precipitator, this position being a certain distance removed along the lengthwise axis of the internal electrode (2) from the first position.

4. Electrostatic precipitator according to claim 3, characterized in that the expansion element (4) and/or spring (5) is located at least partially inside the cavity of the internal electrode (2).

5. Electrostatic precipitator according to claim 3 or claim 4, characterized in that the cleaning body (3) is fixed to the second section (2B) of the internal electrode (2), preferably at the inlet end of the section.

6. Electrostatic precipitator according to claim 3 or claim 4, characterized in that the cleaning body (3) is fixed by connecting members concentrically inside the tube (1) forming the precipitating electrode.

7. Electrostatic precipitator according to claim 2 characterized in that the actuating means (4) is an expansion element which is connected thermally or by a pressure line to an engine-inherent energy source, wherein when the engine is running, the expansion element (4) holds, against a counteracting spring (5), the cleaning body (3) in a first position relative to the fixed first section (2A), when the engine is off, the cleaning body (3) is held by a spring in a second position relative to the fixed first section (2A) of the internal electrode (2), this position being a certain distance removed along the lengthwise axis of the internal electrode (2) from the first position.

8. Electrostatic precipitator according to claim 7, characterized in that the expansion element (4) and/or the spring (5) is located at least partially inside the cavity of the internal electrode (2).

9. Electrostatic precipitator according to claim 7 or 8, characterized in that the internal electrode (2) has, in its hollow second section (2B), at least one slot (2C) extending in the lengthwise direction of the internal electrode (2) for the longitudinally movable accommodation of a retaining element (8) for cleaning body (3), by which element the cleaning body (3) is movably coupled to expansion element (4).

10. Electrostatic precipitator according to claim 9, characterized in that the retaining element (8) runs coaxially at least through a partial region of the precipitating electrode (1A) to center the cleaning body (3).

11. Electrostatic precipitator according to claim 10, characterized in that the retaining element (8) for the cleaning body (3) has a circumferential cleaning lip (8C) for the precipitating electrode (1A), that abuts the precipitating electrode (1A), this lip also serving to center the cleaning body (3).

12. Electrostatic precipitator for collecting liquid or solid particles from a gas stream, consisting of a tube (1) through which the gas to be cleaned flows longitudinally and in which the internal wall (1A) forms a precipitating electrode for the collecting particles, of an internal electrode (2) disposed concentrically and longitudinally inside the tube (1), wherein a high electrical voltage is present in the space between this internal electrode (2) and the precipitating electrode (1A), the internal electrode (2) has on the inlet side a first section (2A) with a small cross-sectional area, and on the outlet side, a second section (2B) with a comparatively larger cross-sectional area, the first section (2A) serving essentially to form the corona, and the second section (2B) serving essentially to form an electrostatic collecting field, characterized in that at least the second section (2B) of the internal electrode (2) is made at least partly hollow, and that the cavity of the internal electrode (2) accommodates at least one part of an actuating means (4) and/or at least one power-transmission means connected to the actuating means (4) for a cleaning device (8, 8C) to clean the precipitating electrode (1A).

13. Electrostatic precipitator according to claim 12, characterized in that the internal electrode (2) has in its hollow second section (2B) at least one slot (2C) extending in the lengthwise direction of the internal electrode (2) for the longitudinally movable accommodation of a cleaning device (8), the cleaning device (8, 8C) being coupled with the actuating means effecting the lengthwise movement of the cleaning device through the cavity of the internal electrode (2).

14. Electrostatic precipitator according to claim 12 or claim 13, characterized in that the cleaning device has a circumferential cleaning lip (8C) abutting precipitating electrode (1A).

15. Electrostatic precipitator according to one of the foregoing claims 1 through 12, characterized in that the cleaning body (3) is formed from an elastomer which is pierced by a first section of the internal electrode (2) which is designed as a needle (2A).
